(19) United States
(12) Patent Application Publication
(10) Pub. No.: US 2005/0274659 A1
(43) Pub. Date: Dec. 15, 2005

(54) Apparatus for automatically replenishing deionized pure water

(76) Inventor: Maxwell Hsu, Chung-Li (TW)

Correspondence Address: Yi-Wen Tseng, 4331 Stevens Battle Lane, Fairfax, VA, 22033, US

(21) Appl. No.: 10/863,467

(22) Filed: Jun. 9, 2004

(51) Int. Cl. B01D 35/14

(52) U.S. Cl. 210/109; 210/335; 210/459; 210/85; 210/86; 210/257.1

(57) ABSTRACT

An apparatus for automatically replenishing the deionized pure water includes a first filter, a second filter, a container and a replenishment unit. The first filter eliminates the extra chlorine, heavy metal, and bacteria of input water by way of an electrochemical oxidation reduction to obtain clean water. The second connected to the first filer eliminates the anion and cation of the clean water from the first filter to obtain pure water to store in the container. The replenishment unit detects the volume of the stored water in the container and a switch is controlled by an outer controlling circuit to perform water replenishment of the container.

### BACKGROUND OF THE INVENTION

The present invention is directed to an apparatus for automatically replenishing the deionized pure water and more particularly, to an apparatus importing and storing the deionized pure water via cleaning treatment to a container. When the deionized pure water within the container is insufficient, an automatic replenishment device can fill the container with deionized pure water.

Owing to the over developments of the land, the mountainsides have been opened up as farms and orchards. Organic matters such us pesticide, insecticide and excrement are flowed into rivers and reservoir with rains and seriously pullet the waters. For plants, nutrients like nitride and phosphide are over much and hence make algae propagated massively. It becomes an obvious index of water deterioration. Therefore, the waterworks is no alternative but adding chlorine to sterilize the water. As time goes on, additive of chlorine becomes more and more increased. According to a research from the National Science Council (NSC) of Taiwan, chlorinated tap water after boiling generates new carcinogens, it is called trihalomethanes, and it turns into a big threat for people health.

In order to solve the foregoing problems, the dealers begin to develop and/or import the ozone producer. It is able to generate ozone to sterilize the water and vegetables, and guarantee the safety for the consumers. When the ozone producer generates ozone, pure water is needed to electrolyze oxygen within the ozone producer. Afterwards, the oxygen is treated to become ozone and then proceed to sterilize the water and vegetables.

However, since the depicted ozone producer cannot directly generate the tap water into pure water, consumers have to buy the pure water and add them into the ozone producer by themselves. Thus, it will cost a lot and make much inconvenience for the consumers to use.

### BRIEF SUMMARY OF THE INVENTION

The present invention relates to an apparatus for automatically replenishing the deionized pure water. It can process water into the deionized pure water and automatically control the replenishment of the pure water. The apparatus includes a first filter, a second filter, a container and a replenishment unit.

The first filter eliminates the extra chlorine, heavy metal, and bacteria of input water by way of an electrochemical oxidation reduction to obtain clean water. The second filter is connected to the first filer, which eliminates anion and cation of the clean water output from the first filter to obtain pure water.

The container with a switch stores and controls the pure water output from the second filter to provide for an ozone producer as an electrolyte. The replenishment unit detects the volume of the stored water in the container and the switch is controlled by an outer controlling circuit to perform water replenishment of the container.

Purifying the primary water by an outer filter, the clean primary water is introduced to the first and the second filter to generate the deionized pure water. Furthermore, the replenishment unit incorporates with the switch controller so that exporting the deinoized pure water into the container for storing and eventually the purpose of automatically replenishing the deinoized pure water is reached.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The above objects and advantages of the present invention will be become more apparent by describing in detail exemplary embodiments thereof with reference to the attached drawings in which:

FIG. 1 illustrates a structural representation of one embodiment according to the present invention.

FIG. 2 illustrates a structural representation of a replenishment unit according to the present invention.

FIG. 3 illustrates a replenishing route representation of one embodiment according to the present invention.

FIG. 4 illustrates an appearance representation of a case according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

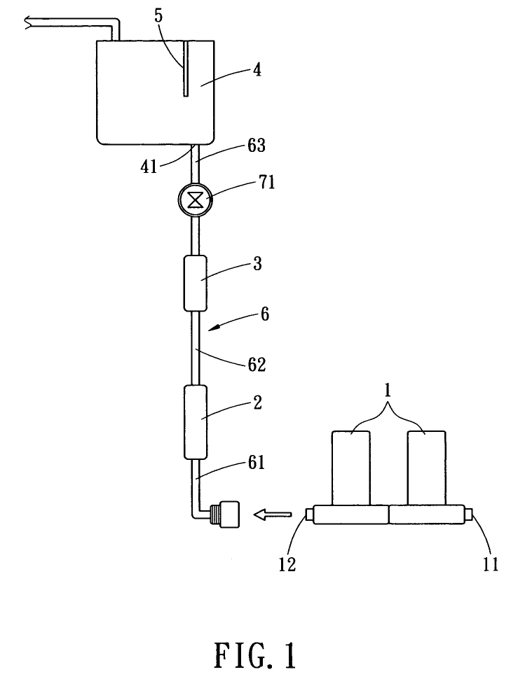

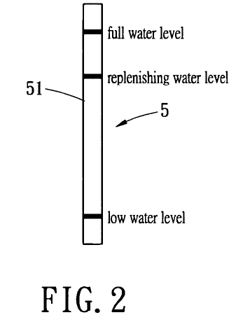

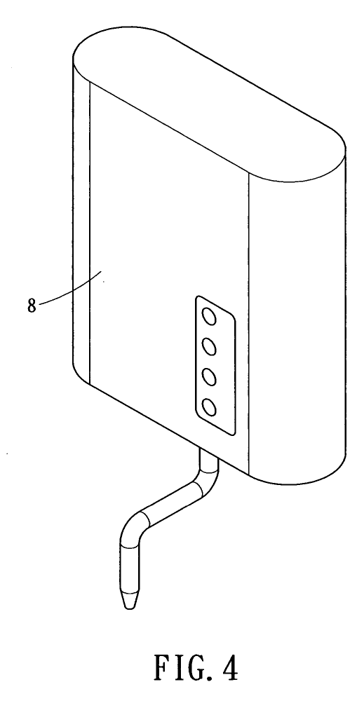

Referring to FIG. 1, it relates to an apparatus of one embodiment of the present invention, which shows an apparatus for automatically replenishing the deionized pure water. The apparatus is provided to filter the primary water introduced by an outer filter 1 and generates the deionized pure water through a first filter 2 and then a second filter 3. The pure water output from the second filter is stored in a container. A switch controller 71 located at an inlet of a container 4 to detect the volume of water within the container 4; and an automatic replenishment unit 5 cooperates with the detection of water amount, as shown in FIG. 2. FIG. 4 representatively shows all components needed in the present apparatus composed within a case 8 excluding the outer filter 1.

Firstly, an outer pipe is connected to an inlet 11 of the outer filter 1 and the primary water such as tap water is introduced through the outer filter 1. An outlet 12 of the outer filter 1 is connected to the first filter 2 by a pipe 61.

The first filter 2 is to filter and eliminate the extra chlorine, heavy metal, and bacteria of the water from the outer filter 1 and then obtain clean water.

The second filter 3 connected to the first filter 2 by a pipe 62 is to eliminate the anion and cation of the clean water from the first filter 2 so as to obtain a highly purified deinoized water, that is the pure water.

The container 4 includes a switch 71 such as an electromagnetic valve and an inlet 41 connected to an outlet of the second filter 3 by a pipe 63. The pure water generated from the second filter 3 is controlled by the switch 71 to input to the container 4. The pure water can be replenished to the container 4 and stored when the switch 71 is open and then provide for an ozone producer as an electrolyte.

The replenishment unit 5 includes a detecting component 51 mounted within the container 4. The detecting component 51 is able to detect the volume of stored water within the container 4. In the preferred embodiment of FIG. 1, the detecting component 51 detecting water under three modes including a full water level, a replenishing water level, and a low water level. When the water volume within the container 4 is under the replenishing water level, the detecting component 51 outputs a signal to an outer controlling circuit and the switch 71 is triggered to be open to replenish the water or to be closed to automatically stop the replenishment when the volume reaches to the full water level.

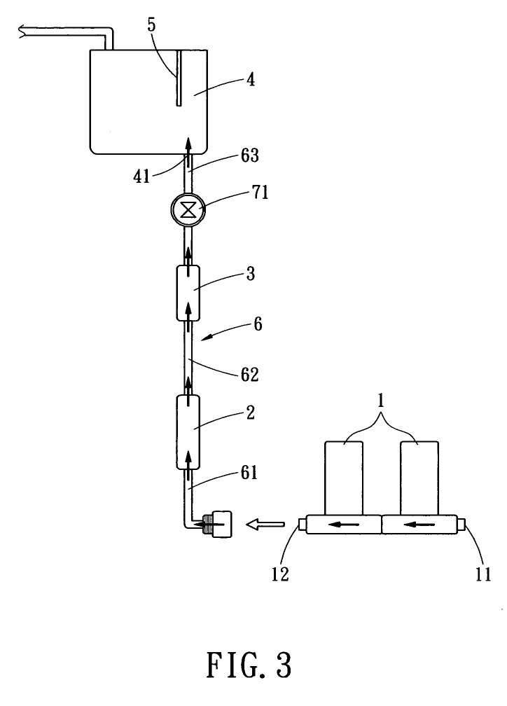

Practical operation of the apparatus for automatically replenishing deionized water is shown in FIG. 3:

Firstly, introducing momentarily the primary water by an inlet 11 to the outer filter 1, the input water is preliminarily cleaned to obtain primary clean water. The water is then further cleaned through the first filter 2 by way of an electrochemical oxidation reduction. Afterwards, through the second filter 3, the pure water is obtained. Under the cooperation of the switch 71 located between the second filter 3 and the container 4, the pure water can be delivered to the container 4 for storage. On the contrary, when the container 4 is in the mode of full water level, the switch 71 will be closed to stop pure water delivery. In conclusion, the replenishment unit 5 momentarily detecting the stored volume of the deionized pure water to achieve automatically water replenishment.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. An apparatus for automatically replenishing deinoized pure water, comprising:
a first filter for receiving water to be treated with an electrochemical oxidation reduction to output clean water;
a second filter connected to the first filter, for receiving the clean water to obtain pure water;
a container for storing the pure water, including a switch;
a replenishment unit for detecting a stored volume of the pure water in the container to automatically control a water replenishment of the container by the switch.

2. The apparatus of claim 1, further comprising an outer filter with an inlet connected to an outer pipe and an outlet connected to the first filter via a pipe.

3. The apparatus of claim 1, wherein the first filter is to eliminate extra chlorine, heavy metal, and bacteria of the water.

4. The apparatus of claim 1, wherein the second filter is to eliminate anion and cation of the clean water.

5. The apparatus of claim 1, wherein the replenishment unit further comprises a detecting component.

6. The apparatus of claim 1, wherein the switch is electromagnetic valve.
